(19) United States
(12) Patent Application Publication
(10) Pub. No.: US 2025/0088921 A1
(43) Pub. Date: Mar. 13, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Rui ZHOU, Beijing (CN)

(73) Assignee: Beijing Xiaomi Mobile Software Co., Ltd., Beijing (CN)

(21) Appl. No.: 18/721,716

(22) PCT Filed: Dec. 27, 2021
(86) PCT No.: PCT/CN2021/141806

§ 371 Date: Jun. 19, 2024

(51) Int. Cl. H04W 36/00; H04W 36/12; H04W 36/24

(52) U.S. Cl. CPC H04W 36/03; H04W 36/12; H04W 36/249

(57) ABSTRACT

An information processing method and an apparatus, a communication device, and a storage medium. The information processing method includes: determining a first duration required for a User Equipment (UE) to switch between an uplink (UL) service and a sidelink (SL) service; and based on the first duration and a second duration, determining start and end moments at which the UE switches between the UL service and the SL service, the second duration is the time interval between a UL time slot and an SL time slot.

### CROSS-REFERENCE TO RELATED APPLICATIONS

The present application is a U.S. National Stage of International Application No. PCT/CN2021/141806, filed on 27 Dec. 2021, the contents of all of which are incorporated herein by reference in their entireties for all purposes.

### BACKGROUND OF THE INVENTION

Vehicle to Everything (V2X) is a new generation of information and communication technology that connects vehicles to everything. V2X may provide two communication interfaces that are referred to as a cellular communication (e.g. Uu) interface and a direct communication (e.g. PC5) interface.

### SUMMARY OF THE INVENTION

Embodiments of the present disclosure provide an information processing method and apparatus, a communication device, and a storage medium.

A first aspect of embodiments of the present disclosure provides an information processing method. The method is performed by a first device and includes: determining a first duration required for a user equipment (UE) to switch between an uplink (UL) service and a sidelink (SL) service; and determining, based on the first duration and a second duration, start and end moments at which the UE switches between the UL service and the SL service, where the second duration is a time interval between a UL time slot and an SL time slot.

A second aspect of embodiments of the present disclosure provides a communication device, including: a memory, and one or more processors, where the one or more processors are collectively configured to: determine a first duration required for a User Equipment (UE) to switch between an uplink (UL) service and a sidelink (SL) service; and determine, based on the first duration and a second duration, start and end moments at which the UE switches between the UL service and the SL service, where the second duration is a time interval between a UL time slot and an SL time slot.

A third aspect of embodiments of the present disclosure provides a non-transitory computer-readable storage medium, storing a computer program instruction, where the computer program instruction when executed by one or more processors cause the one or more processors to execute a method comprising: determining a first duration required for a User Equipment (UE) to switch between an uplink (UL) service and a sidelink (SL) service; and determining, based on the first duration and a second duration, start and end moments at which the UE switches between the UL service and the SL service, where the second duration is a time interval between a UL time slot and an SL time slot.

It should be understood that the foregoing general description and the following detailed description are merely exemplary and explanatory, and are not intended to limit embodiments of the present disclosure.

### BRIEF DESCRIPTION OF DRAWINGS

The accompanying drawings herein are incorporated into and constitute a part of this specification, and illustrate principles that are consistent with embodiments of the present disclosure and are used in conjunction with this specification to explain embodiments of the present disclosure.

FIG. 1 is a schematic structural diagram of a wireless communication system illustrated according to an example embodiment.

FIG. 2 is a schematic diagram of a transmission timeline of a base station and a UE illustrated according to an example embodiment.

FIG. 3 is a flow diagram of an information processing method illustrated according to an example embodiment.

FIG. 4 is a flow diagram of an information processing method illustrated according to an example embodiment.

FIG. 5 is a flow diagram of an information processing method illustrated according to an example embodiment.

FIG. 6 is a flow diagram of an information processing method illustrated according to an example embodiment.

FIG. 7 is a flow diagram of an information processing method illustrated according to an example embodiment.

FIG. 8 is a flow diagram of an information processing method illustrated according to an example embodiment.

FIG. 9 is a schematic diagram of switching time setting for a UE to switch between a UL service and an SL service, illustrated according to an example embodiment.

FIG. 10 is a schematic diagram of switching time setting for a UE to switch between a UL service and an SL service, illustrated according to an example embodiment.

FIG. 11 is a schematic diagram of switching time setting for a UE to switch between a UL service and an SL service, illustrated according to an example embodiment.

FIG. 12 is a flow diagram of an information processing method illustrated according to an example embodiment.

FIG. 13 is a schematic structural diagram an information processing apparatus illustrated according to an example embodiment.

FIG. 14 is a schematic structural diagram of a UE illustrated according to an example embodiment.

FIG. 15 is a schematic structural diagram of a communication device illustrated according to an example embodiment.

### DETAILED DESCRIPTION OF THE INVENTION

Example embodiments will be described in detail herein, and examples of which are presented in the accompanying drawings. When the following description relates to the accompanying drawings, unless specified otherwise, same numbers in different accompanying drawings represent a same or similar element. Implementations described in the following example embodiments do not represent all implementations consistent with embodiments of the present disclosure. On the contrary, the implementations are merely examples of apparatuses and methods that are described in the appended claims in detail and that are consistent with some aspects of embodiments of the present disclosure.

Terms used in embodiments of the present disclosure are merely for the purpose of describing specific embodiments, but are not intended to limit embodiments of the present disclosure. The terms “a” and “the” of singular forms used in embodiments and the appended claims of the present disclosure are also intended to include plural forms, unless otherwise specified in the context clearly. It should also be understood that, the term “and/or” used herein indicates and includes any or all possible combinations of one or more associated listed items.

It should be understood that although the terms “first”, “second”, “third”, and the like may be used in embodiments of the present disclosure to describe various information, the information is not limited by these terms. These terms are merely used to distinguish the same type of information. For example, without departing from the scope of embodiments of the present disclosure, first information may also be referred to as second information, and similarly, second information may also be referred to as first information. Depending on the context, for example, the word “if” used herein may be explained as “while” or “when” or “in response to determining”.

The present disclosure relates to but is not limited to the technical field of wireless communications, and in particular, to an information processing method and apparatus, a communication device, and a storage medium.

Based on the fact that the spectrum demand of operators is increasing day by day, but the actual spectrum available for allocation is gradually decreasing, for the existing licensed frequency bands of operators, simultaneous transmission of a new radio (NR) licensed spectrum service and an NR V2X service on a licensed spectrum is currently a major demand of operators. For a terminal, switching between an NR licensed spectrum service and an NR sidelink (SL) service in the same frequency band will be a very common scenario.

According to the technical solutions provided in embodiments of the present disclosure, start and end moments at which the UE switches between the uplink (UL) service and the SL service are determined based on the first duration required for the UE to switch between the UL service and the SL service and the second duration reserved between the UL time slot and the SL time slot, thereby reducing the communication confusion and poor notification quality caused by the UE randomly determining the start and end moments, and improving the communication quality.

Reference is made to FIG. 1, which illustrates a schematic structural diagram of a wireless communication system provided in an embodiment of the present disclosure. As shown in FIG. 1, the wireless communication system is a communication system based on a cellular mobile communication technology. The wireless communication system may include a plurality of UEs 11 and a plurality of access devices 12.

A UE 11 may be a device that provides voice and/or data connectivity to a user. The UE 11 may communicate with one or more core networks through a radio access network (RAN). The UE 11 may be an Internet of Things UE, for example, a sensor device, a mobile phone (or referred to as a “cellular” phone), and a computer with an Internet of Things UE. For example, the UE 11 may be a fixed, portable, pocket-sized, handheld, computer-built-in or vehicle-mounted apparatus. For example, the UE 11 may be a station (STA), a subscriber unit, a subscriber station, a mobile station, a mobile, a remote station, an access point, a remote UE (remote terminal), an access UE (access terminal), a user apparatus (user terminal), a user agent, a user device, or a user equipment (UE). Alternatively, or additionally, the UE 11 may be a device of an unmanned aerial vehicle. Alternatively, or additionally, the UE 11 may be a vehicle-mounted device. For example, the UE 11 may be a vehicle computer with a wireless communication function, or a wireless communication device externally connected to a vehicle computer. Alternatively, or additionally, the UE 11 may be a roadside device. For example, the UE 11 may be a street lamp, a signal light, or another roadside device with a wireless communication function.

An access device 12 may be a network side device in the wireless communication system. The wireless communication system may be a 4th generation mobile communication technology (4G) system, also referred to as a long term evolution (LTE) system. Alternatively, or additionally, the wireless communication system may be a 5G system, also referred to as a new radio (NR) system or a 5G NR system. Alternatively, or additionally, the wireless communication system may be a next generation system of the 5G system. An access network in the 5G system may be referred to as an NG-RAN (New Generation-Radio Access Network). Alternatively, or additionally, the wireless communication system may be an MTC system.

The access device 12 may be an evolved access device (e.g. eNB) used in the 4G system. Alternatively, or additionally, the access device 12 may be an access device (e.g. gNB) using a central and distributed architecture in the 5G system. When using the central and distributed architecture, the access device 12 usually includes a central unit (CU) and at least two distributed units (DU). Protocol stacks of a packet data convergence protocol (PDCP) layer, a radio link control (RLC) layer, and a media access control (MAC) layer are provided in the central unit. A protocol stack of a physical (PHY) layer is provided in the distributed units. A specific implementation of the access device 12 is not limited in embodiments of the present disclosure.

A wireless connection may be established between an access device 12 and a UE 11 through a wireless air interface. In different implementations, the wireless air interface is a wireless air interface based on standards of the 4th generation mobile communication network technology (4G); alternatively, the wireless air interface is a wireless air interface based on standards of the 5th generation mobile communication network technology (5G), for example, the wireless air interface is new radio; alternatively, the wireless air interface may be a wireless air interface based on standards of the next generation mobile communication network of the 5G.

In some embodiments, an E2E (End to End) connection may also be established between the UEs 11, for example, scenarios such as V2V (vehicle to vehicle) communication, V2I (vehicle to infrastructure) communication, and V2P (vehicle to pedestrian) communication in vehicle to everything (vehicle to everything, V2X) communication.

In some embodiments, the wireless communication system may further include a network management device 13.

The plurality of access devices 12 are separately connected to the network management device 13. The network management device 13 may be a core network device in the wireless communication system. For example, the network management device 13 may be a mobility management entity (MME) in an evolved packet core (EPC). Alternatively, the network management device may be another core network device, for example, a serving gateway (SGW), a public data network gateway (PGW), a policy and charging rules function (PCRF) unit, or a home subscriber server (HSS). An implementation form of the network management device 13 is not limited in embodiments of the present disclosure.

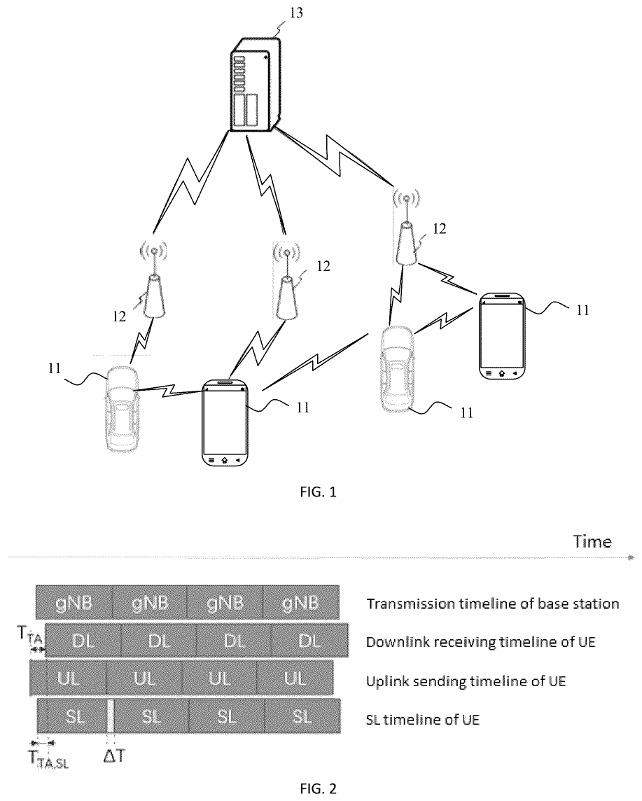

As shown in FIG. 2, when a time slot of an NR licensed spectrum service and switching of an NR SL service are considered, synchronization between time slots of the two services needs to be considered. In coverage of a base station, if the base station is used as a synchronization source, there is a time difference TTA corresponding to an NR uplink time slot between the two time slots. Specifically, for a UE licensed spectrum service, due to a time advance mechanism with a time advance (TA), uplink (UL) transmission of a UE is in advance of downlink (DL) transmission, so as to ensure that uplink subframes of a plurality of UEs are aligned in time when the plurality of UEs arrive at the base station after passing through different paths. An advance value is jointly determined by N_{TA} and N_{TA_offset} that add up to TTA. In NR SL communication of a licensed spectrum cell, N_{TA,SL} is set to 0, and a value of N_{TA_offset} is consistent with a value of N_{TA_offset} of the cell.

For example, when a terminal in coverage of a cell simultaneously performs NR transmission and NR SL transmission, a time advance requirement of the transmission in an NR cell is as follows: an advance of a UL time slot compared with a DL time slot is T_{TA}=(N_{TA}+N_{TA_offset})*Tc, and an advance of an SL time slot compared with the DL time slot is T_{TA,SL}=(N_{TA,SL}+N_{TA_offset})*Tc.

When an NR UL service is switched to the NR SL service, due to a difference between time advances of a UL and an SL, there is a time interval ΔT before the UL time slot ends and the SL time slot starts. For AT, reference is made to FIG. 2, and can be determined using at least Equation (1).

$$Δ T = {T}_{TA} - {T}_{TA , SL} = {N}_{TA} * Tc \qquad Equation ( 1 )$$

Therefore, it is actually considered that ΔT is related to a distance between the terminal and the base station. ΔT is considered in a time for switching between the UL and the SL, thereby making better use of an existing time interval, reducing NR or NR SL time slot resources occupied in the time for switching, reducing system overheads, and achieving higher time-frequency resource utilization.

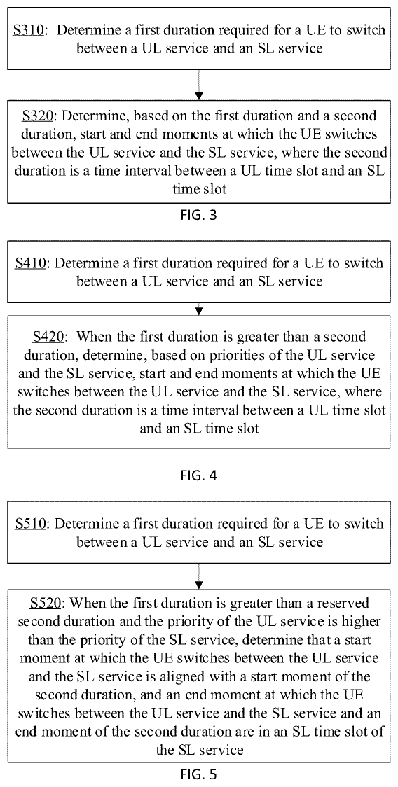

In view of this, as shown in FIG. 3, an embodiment of the present disclosure provides an information processing method. The method is performed by a first device and includes the following steps, S310 and S320.

S310: Determine a first duration required for a UE to switch between a UL service and an SL service.

S320: Determine, based on the first duration and a second duration, start and end moments at which the UE switches between the UL service and the SL service, where the second duration is a time interval between a UL time slot and an SL time slot.

The first device may be a base station or a UE.

S310 may include: determining, based on a capability of the UE, the first duration required for the UE to switch between the SL service and the UL service.

Specifically, S310 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

The switching between the UL service and the SL service herein may at least include: the UE switches from the UL service to the SL service.

The first duration may be represented by Ts. For details, reference is made to FIG. 10 to FIG. 12.

The second duration may be ΔT shown in FIG. 10 to FIG. 12. ΔT may be preconfigured. ΔT is usually determined after the UL time slot and the SL time slot are configured. ΔT is the time interval between the UL time slot and the SL time slot based on a DL time slot that is used as a time anchor.

The SL time slot is used to transmit the SL service. The UL time slot is used to transmit the UL service.

The SL service and the UL service herein are services transmitted by using a same frequency band. For example, both the SL service and the UL service are services transmitted by using a licensed frequency band.

In an embodiment of the present disclosure, the start and end moments at which the UE switches between the UL service and the SL service are determined based on the first duration required for the UE to switch between the UL service and the SL service and the second duration reserved between the UL time slot and the SL time slot, and ΔT is considered in the time for switching between the UL and the SL. Thus, making better use of and improving on the existing time interval, reducing the NR or NR SL time slot resources occupied in the time for switching, reducing the system overheads, and achieving the higher time-frequency resource utilization.

As shown in FIG. 4, an embodiment of the present disclosure provides an information processing method. The method is performed by a first device and includes the following steps S410 and S420.

S410: Determine first duration required for a UE to switch between a UL service and an SL service.

S420: When the first duration is greater than a reserved second duration, determine, based on priorities of the UL service and the SL service, start and end moments at which the UE switches between the UL service and the SL service, where the second duration is a time interval between a UL time slot and an SL time slot.

The first device may be a base station or a UE.

S410 may include: determining, based on a capability of the UE, the first duration required for the UE to switch between the SL service and the UL service.

Specifically, S410 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

The switching between the UL service and the SL service herein may at least include: the UE switches from the UL service to the SL service.

The second duration may be pre-reserved when a network side performs radio resource scheduling, for example, when the network side performs SL time slot and UL time slot configuration.

Referring to FIG. 10 and FIG. 11, if it is found that the first duration required for the UE to switch between the UL service and the SL service is greater than reserved AT when the UE needs to switch between the UL service and the SL service, the UE needs to occupy a portion of the time of the SL time slot and/or the UL time slot when performing switching. For whether the time of the UL time slot or the time of the SL time slot is occupied, the start and end moments at which the UE switches between the UL service and the SL service are determined based on the priorities of the SL service and the UL service. If the first duration is greater than the second duration, the second duration is definitely included in time before the determined start and end moments.

In an embodiment of the present disclosure, to resolve a problem that when the first duration is greater than the second duration, the UE is bound to occupy duration other than the time interval to switch between the UL service and the SL service, a time slot occupied by the UE is determined based on the priorities of the UL service and the SL service. For example, the UE occupies a portion of the time of a time slot corresponding to a low-priority service to switch between the UL service and the SL service, thereby reducing a phenomenon of transmission failure of a high-priority service caused by the UE randomly occupying the SL time slot or the UL time slot.

A higher priority indicates higher importance of a service, or indicates lower tolerance to a transmission delay of a service, and higher sensibility to a packet loss and a bit error. Therefore, to ensure a transmission success rate and/or quality of service (QoS) of the high-priority service, the transmission success rate and QoS of the high-priority service can be at least preferentially ensured by determining a time slot occupied by a time for the UE to switch between the UL service and the SL service.

For example, different types of services have different priorities, and/or services transmitted in different transmission manners have different priorities. For example, some multicast or broadcast important information (for example, emergency avoidance information) may have a high priority.

The start and end moments include a start moment and an end moment. At least one of the start moment and the end moment overlaps with a boundary moment of the second duration. Boundary moments of the second duration include a start moment and an end moment of the second duration.

In an embodiment of the present disclosure, when duration in which the UE switches between the UL service and the SL service is greater than the time interval between the UL time slot and the SL time slot, the start and end moments at which the UE switches between the UL service and the SL service are determined based on the priorities of the UL service and the SL service, thereby ensuring the transmission success rate and QoS of the high-priority service.

As shown in FIG. 5, an embodiment of the present disclosure provides an information processing method. The method is performed by a first device and includes the following steps S510 and S520.

S510: Determine a first duration required for a UE to switch between a UL service and an SL service.

S520: When the first duration is greater than a reserved second duration and the priority of the UL service is higher than the priority of the SL service, determine that a start moment at which the UE switches between the UL service and the SL service is aligned with a start moment of the second duration, and an end moment at which the UE switches between the UL service and the SL service and an end moment of the second duration are in an SL time slot of the SL service.

The first device may be a base station or a UE.

S510 may include: determining, based on a capability of the UE, the first duration required for the UE to switch between the SL service and the UL service.

Specifically, S510 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

The switching between the UL service and the SL service herein may at least include: the UE switches from the UL service to the SL service.

If the priority of the UL service is higher than the priority of the SL service, to ensure an uplink transmission success rate and quality of service (QOS) of the UL service of the UE, a time for the UE to switch between the UL service and the SL service may be aligned with an end moment of a UL time slot, namely the start moment of the second duration, and an end moment of the time for the UE to switch between the UL service and the SL service naturally falls in the SL time slot.

As shown in FIG. 10, when the priority of the UL service is higher than the priority of the SL service, the first duration not only occupies the second duration, but also occupies a portion of the time that is of the SL time slot and that is adjacent to the second duration. In FIG. 10, the UL time slot N is a previous time slot of the SL time slot N+1. That is, the end moment of the time in which the UE switches between the UL service and the SL service is in the SL time slot, and the start moment is aligned with the start moment of the second duration.

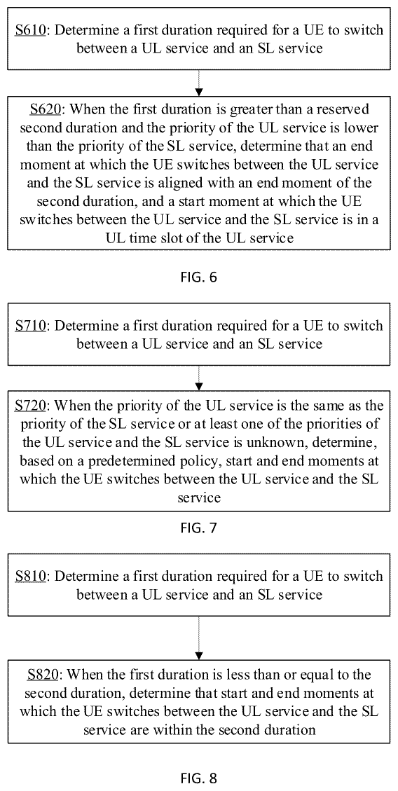

As shown in FIG. 6, an embodiment of the present disclosure provides an information processing method. The method is performed by a first device and includes the following steps S610 and S620.

S610: Determine a first duration required for a UE to switch between a UL service and an SL service.

S620: When the first duration is greater than a reserved second duration and the priority of the UL service is lower than the priority of the SL service, determine that an end moment at which the UE switches between the UL service and the SL service is aligned with an end moment of the second duration, and a start moment at which the UE switches between the UL service and the SL service is in a UL time slot of the UL service.

The first device may be a base station or a UE.

S610 may include: determining, based on a capability of the UE, the first duration required for the UE to switch between the SL service and the UL service.

Specifically, S610 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

The switching between the UL service and the SL service herein may at least include: the UE switches from the UL service to the SL service.

When the priority of the UL service is lower than the priority of the SL service, it is determined that the end moment at which the UE switches between the UL service and the SL service is aligned with the end moment of the second duration, and the start moment at which the UE switches between the UL service and the SL service is in the UL time slot of the UL service.

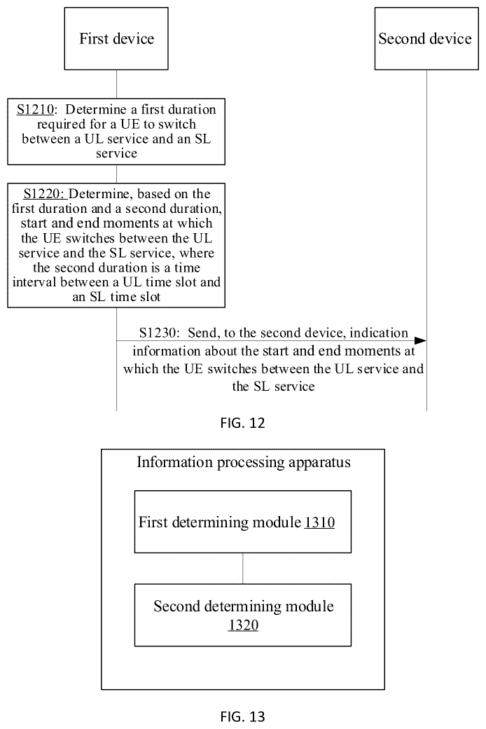

As shown in FIG. 12, when the priority of the UL service is lower than the priority of the SL service, the first duration not only occupies the second duration, but also occupies a portion of the time that is of the UL time slot and that is adjacent to the second duration. In FIG. 12, the UL time slot N is a previous time slot of an SL time slot N+1. In this case, the start moment at which the UE switches between the UL service and the SL service is in the UL time slot, and the end moment is aligned with the end moment of the second duration.

Thus, if the priority of the UL service is lower than the priority of the SL service, to ensure a transmission success rate and/or QoS of the SL service of the UE, it is preferentially considered that the UE occupies the time of the UL time slot to switch between the UL service and SL service. Therefore, the end moment of a time for the UE to switch between the UL service and the SL service is the end moment of the second duration, but the start moment is in the UL time slot, so as to ensure preferential transmission of the SL service with the high priority.

As shown in FIG. 7, an embodiment of the present disclosure provides an information processing method. The method is performed by a first device and includes the following steps S710 and S720.

S710: Determine a first duration required for a UE to switch between a UL service and an SL service.

S720: When the priority of the UL service is the same as the priority of the SL service or at least one of the priorities of the UL service and the SL service is unknown, determine, based on a predetermined policy, start and end moments at which the UE switches between the UL service and the SL service.

The first device may be a base station or a UE.

S710 may include: determining, based on a capability of the UE, the first duration required for the UE to switch between the SL service and the UL service.

Specifically, S710 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

The switching between the UL service and the SL service herein may at least include: the UE switches from the UL service to the SL service.

If the priority of the UL service is the same as the priority of the SL service, for the UE, the UL service and the SL service are equally important. In this case, start and end moments at which the UE switches between the UL service and the SL service may be determined based on the predetermined policy.

Alternatively, when the priority of any of the UL service and the SL service is unknown, the priorities of the two services cannot be compared. In this case, start and end moments at which the UE switches between the UL service and the SL service may be determined based on the predetermined policy.

The predetermined policy may be a policy predetermined according to an agreement or a policy sent by a network device, for example, a policy delivered by a core network device or the base station. The core network device includes but is not limited to a policy control function (PCF) and the like.

The predetermined policy includes but is not limited to at least one of the following.
(1) a random policy, indicating to randomly occupy a portion of the time of an SL time slot or a UL time slot as a supplement to the second duration, to achieve the first duration required for the UE to perform switching.
(2) a priority threshold policy, which may be applied in a scenario in which one of the priorities of the UL service and the SL service is known, and the other is unknown. If the known priority is higher than a first priority threshold, a portion of the time of a time slot corresponding to the service with the unknown priority is occupied as the duration required for the UE to switch between the UL service and the SL service. If the known priority is lower than a second priority threshold, a portion of the time of a time slot corresponding to the service with the known priority is occupied as the duration required for the UE to switch between the UL service and the SL service. The priority corresponding to the second priority threshold may be lower than or equal to the priority corresponding to the first priority threshold. If the known priority is higher than the first priority threshold, it is indicated that the priority of the service is sufficiently high, and there is a high probability that the unknown priority is lower than the known priority of the service. If the known priority is lower than the second priority threshold, it is indicated that the known priority is sufficiently low, and there is a high probability that the unknown priority is higher than the known priority.

As shown in FIG. 8, an embodiment of the present disclosure provides an information processing method. The method is performed by a first device and includes the following steps S810 and S820.

S810: Determine a first duration required for a UE to switch between a UL service and an SL service.

S820: When the first duration is less than or equal to the second duration, determine that start and end moments at which the UE switches between the UL service and the SL service are within the second duration.

The first device may be a base station or a UE.

S810 may include: determining, based on a capability of the UE, the first duration required for the UE to switch between the SL service and the UL service.

Specifically, S810 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

When the first duration is less than or equal to the second duration, it is indicated that the UE may complete switching within a reserved duration. Thus, the start and end moments of the first duration may both be set in the second duration, and therefore the UE can switch between the UL service and the SL service without occupying the time of the UL time slot or the SL time slot.

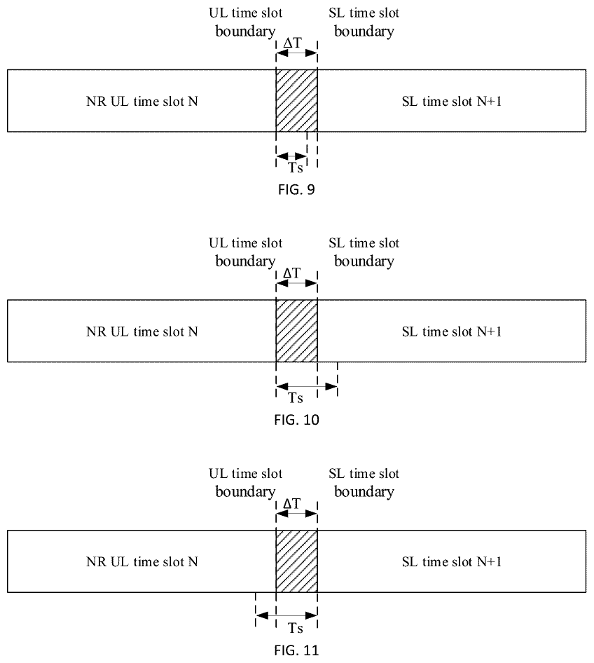

As shown in FIG. 9, when the first duration is less than the second duration, a whole time for the UE to switch between the UL service and the SL service is within the second duration. For example, when a start moment of the time for the UE to switch between the UL service and the SL service is aligned with a start moment of the second duration, even if the UE has a delay in a switching process due to some cases, the UE can still complete switching between the UL service and the SL service in the second duration provided that the UE recovers in time.

As shown in FIG. 12, an embodiment of the present disclosure provides an information processing method. The method includes the following steps, S1210-S1230.

S1210: Determine a first duration required for a UE to switch between a UL service and an SL service.

S1220: Determine, based on the first duration and a second duration, start and end moments at which the UE switches between the UL service and the SL service, where the second duration is a time interval between a UL time slot and an SL time slot.

S1230: Send, to a second device, indication information about the start and end moments at which the UE switches between the UL service and the SL service.

The first device is a base station, and the second device is the UE; or the first device is the UE, and the second device is the base station.

S1210 may include: determining, based on a capability of the UE, the first duration required for the UE to switch between the SL service and the UL service.

Specifically, S1210 may include: determining, based on a radio frequency switching capability of the UE, the first duration required for the UE to switch between the SL service and the UL service.

The radio frequency switching capability includes: adjustment, power-off/power-on and other processes of a radio frequency device in an operating state which may occur in a process in which the UE switches between an SL corresponding to the SL service and an SL corresponding to the UL service.

The switching between the UL service and the SL service herein may at least include: the UE switches from the UL service to the SL service.

S1220 may include: when the first duration is greater than the second duration, determining, based on priorities of the UL service and the SL service, the start and end moments at which the UE switches between the UL service and the SL service; and/or when the first duration is less than or equal to the second duration, determining that the start and end moments at which the UE switches between the UL service and the SL service are within the second duration.

Specifically, when the first duration is greater than the second duration, determining, based on the priorities of the UL service and the SL service, the start and end moments at which the UE switches between the UL service and the SL service includes at least one of the following.
(1) when the priority of the UL service is higher than the priority of the SL service, determining that a start moment at which the UE switches between the UL service and the SL service is aligned with a start moment of the second duration, and an end moment at which the UE switches between the UL service and the SL service and an end moment of the second duration are in the SL time slot of the SL service.
(2) when the priority of the UL service is lower than the priority of the SL service, determining that an end moment at which the UE switches between the UL service and the SL service is aligned with an end moment of the second duration, and a start moment at which the UE switches between the UL service and the SL service is in the UL time slot of the UL service.
(3) when the priority of the UL service is the same as the priority of the SL service or at least one of the priorities of the UL service and the SL service is unknown, determining, based on a predetermined policy, the start and end moments at which the UE switches between the UL service and the SL service.

For example, the predetermined policy may be a policy predetermined according to an agreement or a policy sent by a network device, for example, a policy delivered by a core network device or the base station. The core network device includes but is not limited to a policy control function (PCF) and the like.

The predetermined policy includes but is not limited to at least one of the following.
(1) a random policy, indicating to randomly occupy a portion of the time of an SL time slot or a UL time slot as a supplement to the second duration, to achieve the first duration required for the UE to perform switching.
(2) a priority threshold policy, which may be applied in a scenario in which one of the priorities of the UL service and the SL service is known, and the other is unknown. If the known priority is higher than a first priority threshold, a portion of the time of a time slot corresponding to the service with the unknown priority is occupied as the duration required for the UE to switch between the UL service and the SL service. If the known priority is lower than a second priority threshold, a portion of the time of a time slot corresponding to the service with the known priority is occupied as the duration required for the UE to switch between the UL service and the SL service. The priority corresponding to the second priority threshold may be lower than or equal to the priority corresponding to the first priority threshold. If the known priority is higher than the first priority threshold, it is indicated that the priority of the service is sufficiently high, and there is a high probability that the unknown priority is lower than the known priority of the service.

If the known priority is lower than the second priority threshold, it is indicated that the known priority is sufficiently low, and there is a high probability that the unknown priority is higher than the known priority.

If the first device is the base station, a first base station notifies, through various downlink messages, the UE of the start and end moments at which the UE switches between the UL service and the SL service. If the first device is the UE, the UE notifies, through an uplink message, the base station of the start and end moments determined by the UE.

Thus, both the UE and the base station know a specific time for the UE to switch between the UL service and the SL service.

If the first device is the UE, after determining the start and end moments, the UE sends the indication information to the base station. After receiving the indication information and if agreeing with the start and end moments determined by the UE, the base station sends acknowledgment indication (ACK) to the UE. After receiving the ACK, the UE switches between the UL service and the SL service based on the determined start and end moments. If not agree, the base station sends indication information about start and end moments re-determined by the base station to the UE. For example, in some scenarios, the determined start and end moments are not appropriate because the UE knows only one priority, while the base station knows both the priorities of the UL service and the SL service, and therefore the base station may determine more appropriate start and end moments. In this case, the base station may indicate, in feedback information in response to the indication information reported by the UE, the start and end moments determined by the base station.

In another embodiment, if not agree with the start and end moments reported by the UE, the base station may send only negative acknowledgment indication (NACK) to the UE, and the UE automatically adjusts, based on the NACK, a time slot occupied by the time for switching. For example, if the original start and end moments reported by the UE occupy a portion of the time of the UL time slot in addition to the second duration, after the UE receives the NACK of the base station, both the UE and the base station agree that the time for the UE to switch between the UL service and the SL service occupies a portion of the time of the SL time slot in addition to the second duration.

Information content of the indication information is as follows: time information of a start moment and time information of an end moment; time information of a start moment and a time offset; and an offset value and an offset type identifier, where the offset type identifier indicates whether a current offset is a forward offset relative to the start moment of the second duration or a backward offset relative to the end moment of the second duration. The offset value indicates the offset duration of a start moment of switching duration in which the UE switches between the UL service and the SL service relative to the start moment of the second duration, or the offset duration of an end moment of the switching duration in which the UE switches between the UL service and the SL service relative to the end moment of the second duration.

One of ordinary skill in the art would understand that this is merely an example of the information content of the indication information. During specific implementation, the information content is not limited to the described examples.

In one embodiment, determining the first duration required for the UE to switch between the UL service and the SL service includes: determining the first duration based on a UE capability.

The UE capability includes but is not limited to a radio frequency switching capability of a terminal. If different types of UEs have different capabilities, first durations required are different. Therefore, even if the UEs are located within a same distance from the base station, and second durations are the same, some UEs need a time exceeding the second duration to switch between the UL service and the SL service, while some UEs may complete switching between the UL service and the SL service well within the second duration.

In some embodiments, the second duration is determined based on a time advance of the UE.

For example, the second duration is N_{TA}*Tc.

In some embodiments, T_{TA}=(N_{TA}+N_{TA_offset})*Tc.

$${T}_{TA , SL} = ( {N}_{TA , SL} + {N}_{TA \_ offset} ) * Tc . \\ {N}_{TA} * Tc = {T}_{TA} - {T}_{TA , SL} = ( {N}_{TA} - {N}_{TA , SL} ) * Tc = {N}_{TA} * Tc , where \\ {N}_{TA} = {N}_{TA} - {N}_{TA , SL} .$$

In some embodiments, N_{TA,SL} may be 0.
T_{TA} is a UL time advance of the UE, and is determined based on a position of the UE relative to the base station.
T_{TA,SL} is an SL time advance of the UE.
N_{TA_offset} is a fixed value for calculating the time advance.

In some embodiments, Tc=1/(Δfₘₐₓ*N_{f}), where Δfₘₐₓ may be equal to 480*103 Hz, and N_{f} may be equal to 4096. Certainly, this is an example of duration of Tc. During specific implementation, the duration is not limited to the example.

For switching between an NR service and an NR SL service in a licensed spectrum, a switching method for implementing a switching process with reference to a time difference existing between a UL time slot and an SL time slot to achieve higher time-frequency resource utilization is proposed.

In addition, considering that the switching time Ts is greater than ΔT, that is, switching cannot be completed within a time range of ΔT, a method for determining a switching time setting location based on priorities of data of NR transmission and NR SL transmission before and after the switching is provided.

The UE reports its switching time Ts (equivalent to the foregoing first duration), and the network device determines how to specifically set the switching time for the UE to switch between the UL service and the SL service by determining a relationship between Ts and ΔT (equivalent to the foregoing second duration). The network device includes but is not limited to the base station. After determining the switching time, the network device may further adjust, as required, transmission time of the UL service in the UL time slot and/or transmission time of the SL service in the SL time slot.

For example, if Ts<ΔT, that is, the UE may complete switching within a time interval between the UL time slot and an NR SL time slot, the UE uses a manner of starting switching when an NR time slot ends. A specific switching time is shown in FIG. 9.

If Ts>AT, switching performed by the UE cannot be completed in the time range of ΔT, and a portion of the time of the NR time slot or the NR SL time slot needs to be occupied as system overheads to complete the switching.

It is assumed that the priority of content transmitted in the UL time slot of NR is P1, and the priority of content transmitted in the NR SL time slot is P2.

When Ts>ΔT, if P1>P2, a method in which the switching time occupies a part of the NR SL time slot is used. Specific switching is: switching starts when the NR time slot ends, duration is Ts, and AT and a portion of the time of the NR SL time slot are occupied to complete the switching. Details are shown in FIG. 10.

When Ts>ΔT, if P1<P2, a method in which the switching time occupies a part of the NR time slot is used. Specific switching is: switching starts in Ts-AT before the NR time slot ends, and duration is Ts. Details are shown in FIG. 11.

If P1=P2, or one or both of P1 and P2 are unknown, the network device or the UE determines how to implement switching in any way.

As shown in FIG. 13, an embodiment of the present disclosure provides an information processing apparatus 1300. The information processing apparatus 1300 includes a first determining module 1310 and a second determining module 1320.

The first determining module 1310, configured to determine a first duration required for a UE to switch between an uplink (UL) service and a sidelink (SL) service.

The second determining module 1320, configured to determine, based on the first duration and a second duration, start and end moments at which the UE switches between the UL service and the SL service, where the second duration is a time interval between a UL time slot and an SL time slot.

The information processing apparatus 1300 may be included in a first device. The first device may be a base station or a UE.

In some embodiments, the first determining module 1310 and the second determining module 1320 may be program modules. After the program modules are executed by a processor, the first duration can be determined, and the start and end moments at which the UE switches between the UL service and the SL service can be determined based on values of the first duration and the second duration.

In some other embodiments, the first determining module 1310 and the second determining module 1320 may be software and hardware combination modules. The software and hardware combination modules include but are not limited to various programmable arrays. The programmable arrays include but are not limited to a field programmable array and/or a complex programmable array.

In some other embodiments, the first determining module 1310 and the second determining module 1320 may be pure hardware modules. The pure hardware modules include but are not limited to an application specific integrated circuit.

In some embodiments, the second determining module 1320 is configured to: when the first duration is greater than the second duration, determine, based on priorities of the UL service and the SL service, the start and end moments at which the UE switches between the UL service and the SL service.

In some embodiments, the second determining module 1320 is configured to: when the priority of the UL service is higher than the priority of the SL service, determine that a start moment at which the UE switches between the UL service and the SL service is aligned with a start moment of the second duration, and an end moment at which the UE switches between the UL service and the SL service and an end moment of the second duration are in the SL slot of the SL service.

In some embodiments, the second determining module 1320 is configured to: when the priority of the UL service is lower than the priority of the SL service, determine that an end moment at which the UE switches between the UL service and the SL service is aligned with an end moment of the second duration, and a start moment at which the UE switches between the UL service and the SL service is in the UL time slot of the UL service.

In some embodiments, the second determining module 1320 is further configured to: when the priority of the UL service is the same as the priority of the SL service or at least one of the priorities of the UL service and the SL service is unknown, determine, based on a predetermined policy, the start and end moments at which the UE switches between the UL service and the SL service.

In some embodiments, the second determining module 1320 is further configured to: when the first duration is less than or equal to the second duration, determine that the start and end moments at which the UE switches between the UL service and the SL service are within the second duration.

In some embodiments, the information processing apparatus 1300 further includes a sending module (not shown), configured to send, to a second device, indication information about the start and end moments at which the UE switches between the UL service and the SL service.

The first device is the base station, and the second device is the UE; or the first device is the UE, and the second device is the base station.

In some embodiments, the first determining module 1310 is configured to determine the first duration based on a UE capability.

In some embodiments, the second duration is determined based on a time advance of the UE.

An embodiment of the present disclosure provides a communication device, including: a memory, configured to store instructions that can be executed by a processor; and the processor, connected to the memory. The processor is configured to perform the information processing method provided in any one of the foregoing technical solutions.

The processor may include various types of storage media. The storage media are non-transitory computer storage media that can continue to memorize information stored in the storage media after the communication device is powered off.

The communication device includes a UE or a base station.

The processor may be connected to the memory through a bus and the like, and is configured to read an executable program stored in the memory, for example, at least one of the methods shown in FIG. 3 to FIG. 8.

An embodiments of the present disclosure provides an information processing method. The method is performed by a first device and includes: determining a first duration required for a UE to switch between an uplink (UL) service and a sidelink (SL) service; and determining, based on the first duration and a second duration, start and end moments at which the UE switches between the UL service and the SL service, where the second duration is a time interval between a UL time slot and an SL time slot.

Based on the foregoing solution, determining, based on the first duration and a second duration, the start and end moments at which the UE switches between the UL service and the SL service includes: in response to the first duration being greater than the second duration, determining, based on priorities of the UL service and the SL service, the start and end moments at which the UE switches between the UL service and the SL service.

Based on the foregoing solution, determining, based on priorities of the UL service and the SL service, the start and end moments at which the UE switches between the UL service and the SL service includes: in response to the priority of the UL service being higher than the priority of the SL service, determining that a start moment at which the UE switches between the UL service and the SL service is aligned with a start moment of the second duration, and an end moment at which the UE switches between the UL service and the SL service and an end moment of the second duration are in the SL time slot of the SL service.

Based on the foregoing solution, determining, based on priorities of the UL service and the SL service, the start and end moments at which the UE switches between the UL service and the SL service includes: in response to the priority of the UL service being lower than the priority of the SL service, determining that an end moment at which the UE switches between the UL service and the SL service is aligned with an end moment of the second duration, and a start moment at which the UE switches between the UL service and the SL service is in the UL time slot of the UL service.

Based on the foregoing solution, determining, based on priorities of the UL service and the SL service, the start and end moments at which the UE switches between the UL service and the SL service includes: in response to the priority of the UL service being the same as the priority of the SL service or at least one of the priorities of the UL service and the SL service being unknown, determining, based on a predetermined policy, the start and end moments at which the UE switches between the UL service and the SL service.

Based on the foregoing solution, determining, based on the first duration and a second duration, the start and end moments at which the UE switches between the UL service and the SL service further includes: in response to the first duration being less than or equal to the second duration, determining that the start and end moments at which the UE switches between the UL service and the SL service are within the second duration.

Based on the foregoing solution, the method further includes: sending, to a second device, indication information about start and end moments at which the UE switches between the UL service and the SL service.

The first device is a base station, and the second device is the UE; or the first device is the UE, and the second device is the base station.

Based on the foregoing solution, determining a first duration required for a UE to switch between an uplink (UL) service and a sidelink (SL) service includes: determining the first duration based on a UE capability.

Based on the foregoing solution, the second duration is determined based on a time advance of the UE.

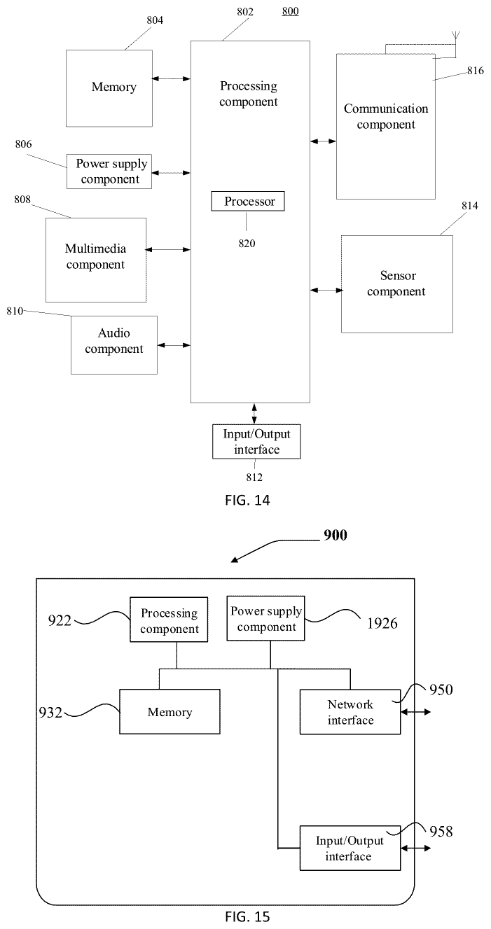

FIG. 14 is a block diagram of a UE 800 illustrated according to an example embodiment. For example, the UE 800 may be a mobile phone, a computer, a digital broadcast user device, a message sending and receiving device, a gaming console, a tablet device, medical equipment, fitness equipment, a personal digital assistant, and the like.

Referring to FIG. 14, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operations of the UE 800, such as operations associated with display, a telephone call, data communication, camera, and recording. The processing component 802 may include one or more processors 820 to execute instructions, so as to complete all or some of the steps of the foregoing methods. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to store various types of data to support operations of the UE 800. Examples of the data include instructions of any application or method operated on the UE 800, contact data, phone book data, messages, pictures, videos, and the like. The memory 804 may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power supply component 806 provides power to various components of the UE 800. The power supply component 806 may include a power management system, one or more power supplies, and other components related to power generation, management, and distribution of the UE 800.

The multimedia component 808 includes a screen that provides an output interface and that is between the UE 800 and a user. In some embodiments, the screen may include a liquid crystal display (LCD) and a touch panel (TP). If the screen includes the touch panel, the screen may be implemented as a touchscreen, so as to receive an input signal from the user. The touch panel includes one or more touch sensors to sense touching, sliding, and a gesture on the touch panel. The touch sensor may not only sense a boundary of a touch or slide action, but also detect duration and pressure related to the touch or slide action. In some embodiments, the multimedia component 808 includes a front camera and/or a rear camera. When the UE 800 is in an operation mode, for example, a shooting mode or a video mode, the front camera and/or the rear camera may receive external multimedia data. Each front camera and rear camera may be a fixed optical lens system that has a focal length and an optical zoom capability.

The audio component 810 is configured to output and/or input an audio signal. For example, the audio component 810 includes a microphone (MIC). When the UE 800 is in the operation mode, for example, a call mode, a recording mode, and a speech recognition mode, the microphone is configured to receive an external audio signal. The received audio signal may be further stored in the memory 804 or sent via the communication component 816. In some embodiments, the audio component 810 further includes a speaker for outputting the audio signal.

The I/O interface 812 provides an interface between the processing component 802 and a peripheral interface module. The peripheral interface module may be a keyboard, a scroll wheel, buttons, and the like. These buttons may include but are not limited to: a home page button, a volume button, a start button, and a locking button.

The sensor component 814 includes one or more sensors, configured to provide status evaluation in various aspects for the UE 800. For example, the sensor component 814 may detect an on/off state of the UE 800 and relative positioning of components. For example, the components are a display and a keypad of the UE 800, and the sensor component 814 may further detect a change of position of the UE 800 or a component of the UE 800, the presence or absence of contact between the user and the UE 800, an orientation or acceleration/deceleration of the UE 800, and a change of temperature of the UE 800. The sensor component 814 may include a proximity sensor, configured to detect the presence of a nearby object without any physical contact. The sensor component 814 may further include an optical sensor, for example, a CMOS or CCD image sensor, used in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and another device. The UE 800 may access a wireless network based on a communication standard, for example, Wi-Fi, 2G or 3G, or a combination thereof. In an example embodiment, the communication component 816 receives a broadcast signal or broadcast related information from an external broadcast management system via a broadcast channel. In an example embodiment, the communication component 816 further includes a near field communication (NFC) module, so as to facilitate short range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example embodiment, the UE 800 may be implemented by one or more application specific integrated circuits (ASICs), a digital signal processor (DSPS), a digital signal processing device (DSPD), a programmable logic device (PLDS), a field programmable gate array (FPGA), a controller, a microcontroller, a microprocessor, or other electronic components, for performing the foregoing methods.

In an example embodiment, a non-transitory computer-readable storage medium including instructions, for example, the memory 804 including instructions, is further provided, and the instructions may be executed by the processor 820 of the UE 800 to complete the foregoing methods. For example, the non-transitory computer-readable storage medium may be a ROM, a random access memory (RAM), a CD-ROM, a magnetic tape, a floppy disk, an optical data storage device, and the like.

As shown in FIG. 15, an embodiment of the present disclosure shows a structure of an access device. For example, a communication device 900 may be provided as the access device or a network side device. The communication device 900 may be the foregoing base station.

Referring to FIG. 15, the communication device 900 includes a processing component 922, and further includes one or more processors (not shown), and a memory resource represented by a memory 932, configured to store instructions that can be executed by the processing component 922, for example, an application program. The application program (not shown) stored in the memory 932 may include one or more modules each of which corresponds to a set of instructions. In addition, the processing component 922 is configured to execute the instructions to perform any of the foregoing methods performed by the access device, for example, the methods shown in FIG. 3 to FIG. 8.

The communication device 900 may further include a power supply component 926 that is configured to perform power management for the communication device 900, a wired or wireless network interface 950 that is configured to connect the communication device 900 to the network, and an input/output (I/O) interface 958. The communication device 900 may perform an operation based on an operating system stored in the memory 932, for example, Windows Server™, Mac OS X™, Unix™, Linux™, FreeBSD™, and the like.

A person skilled in the art is readily conceivable of other implementation solutions of the present disclosure after considering this specification and practicing the disclosure that is disclosed herein. The present disclosure is intended to cover any variations, functions, or adaptive changes of the present disclosure. These variations, functions, or adaptive changes comply with general principles of the present disclosure, and include common knowledge or customary technical means in the technical field that is not disclosed in the present disclosure. This specification and embodiments are merely deemed as examples, the actual scope and spirit of the present disclosure are indicated by the claims below.

It should be understood that the present disclosure is not limited to the precise structure described herein and shown in the accompanying drawings, and various modifications and changes may be made without departing from the scope of the present disclosure. The scope of the present disclosure is merely limited by the appended claims.

1. An information processing method, performed by a first device, the method comprising:
determining a first duration required for a User Equipment (UE) to switch between an uplink (UL) service and a sidelink (SL) service; and
determining, based on the first duration and a second duration, start and end moments at which the UE switches between the UL service and the SL service, wherein
the second duration is a time interval between a UL time slot and an SL time slot.

2. The method according to claim 1, wherein determining, based on the first duration and the second duration, the start and end moments at which the UE switches between the UL service and the SL service comprises:
in response to the first duration being greater than the second duration, determining, based on a priority of the UL service and a priority of the SL service, the start and end moments at which the UE switches between the UL service and the SL service.

3. The method according to claim 2, wherein determining, based on the priority of the UL service and the priority of the SL service, the start and end moments at which the UE switches between the UL service and the SL service comprises:
in response to the priority of the UL service being higher than the priority of the SL service, determining that a start moment at which the UE switches between the UL service and the SL service is aligned with a start moment of the second duration, and an end moment at which the UE switches between the UL service and the SL service and an end moment of the second duration are in the SL time slot of the SL service.

4. The method according to claim 2, wherein determining, based on the priority of the UL service and the priority of the SL service, the start and end moments at which the UE switches between the UL service and the SL service comprises:
in response to the priority of the UL service being lower than the priority of the SL service, determining that an end moment at which the UE switches between the UL service and the SL service is aligned with an end moment of the second duration, and a start moment at which the UE switches between the UL service and the SL service is in the UL time slot of the UL service.

5. The method according to claim 2, wherein determining, based on the priority of the UL service and the priority of the SL service, the start and end moments at which the UE switches between the UL service and the SL service comprises:
in response to the priority of the UL service being the same as the priority of the SL service or at least one of the priority of the UL service and the priority of the SL service being unknown, determining, based on a predetermined policy, the start and end moments at which the UE switches between the UL service and the SL service.

6. The method according to claim 1, wherein determining, based on the first duration and the second duration, the start and end moments at which the UE switches between the UL service and the SL service further comprises:
in response to the first duration being less than or equal to the second duration, determining that the start and end moments at which the UE switches between the UL service and the SL service are within the second duration.

7. The method according to claim 1, further comprising:
sending, to a second device, indication information about the start and end moments at which the UE switches between the UL service and the SL service, wherein
the first device is a base station, and the second device is the UE; or the first device is the UE, and the second device is the base station.

8. The method according to claim 1, wherein determining the first duration required for the UE to switch between the UL service and the SL service comprises:
determining the first duration based on a UE capability.

9. The method according to claim 1, wherein the second duration is determined based on a time advance of the UE.

10.-18. (canceled)

19. A communication device, comprising:
a memory, and
one or more processors, wherein the one or more processors are collectively configured to:
determine a first duration required for a User Equipment (UE) to switch between an uplink (UL) service and a sidelink (SL) service; and
determine, based on the first duration and a second duration, start and end moments at which the UE switches between the UL service and the SL service, and
wherein the second duration is a time interval between a UL time slot and an SL time slot.

20. A non-transitory computer-readable storage medium, storing computer program instruction, wherein the computer program instruction when executed by one or more processors cause the one or more processors to execute a method comprising:
determining a first duration required for a User Equipment (UE) to switch between an uplink (UL) service and a sidelink (SL) service; and
determining, based on the first duration and a second duration, start and end moments at which the UE switches between the UL service and the SL service, and
wherein the second duration is a time interval between a UL time slot and an SL time slot.

21. The communication device according to claim 19, wherein the one or more processors are further collectively configured to:
in response to the first duration being greater than the second duration, determine, based on a priority of the UL service and a priority of the SL service, the start and end moments at which the UE switches between the UL service and the SL service.

22. The communication device according to claim 21, wherein the one or more processors are further collectively configured to:
in response to the priority of the UL service being higher than the priority of the SL service, determine that a start moment at which the UE switches between the UL service and the SL service is aligned with a start moment of the second duration, and an end moment at which the UE switches between the UL service and the SL service and an end moment of the second duration are in the SL time slot of the SL service.

23. The communication device according to claim 21, wherein the one or more processors are further collectively configured to:
in response to the priority of the UL service being lower than the priority of the SL service, determine that an end moment at which the UE switches between the UL service and the SL service is aligned with an end moment of the second duration, and a start moment at which the UE switches between the UL service and the SL service is in the UL time slot of the UL service.

24. The communication device according to claim 21, wherein the one or more processors are further collectively configured to:
in response to the priority of the UL service being the same as the priority of the SL service or at least one of the priority of the UL service and the priority of the SL service being unknown, determine, based on a predetermined policy, the start and end moments at which the UE switches between the UL service and the SL service.

25. The communication device according to claim 19, wherein the one or more processors are further collectively configured to:
in response to the first duration being less than or equal to the second duration, determine that the start and end moments at which the UE switches between the UL service and the SL service are within the second duration.

26. The communication device according to claim 19, wherein the one or more processors are further collectively configured to:
send, to a second device, indication information about the start and end moments at which the UE switches between the UL service and the SL service, wherein
the first device is a base station, and the second device is the UE; or the first device is the UE, and the second device is the base station.

27. The communication device according to claim 19, wherein the one or more processors are further collectively configured to:
determine the first duration based on a UE capability.

28. The communication device according to claim 19, wherein the second duration is determined based on a time advance of the UE.

29. The non-transitory computer-readable storage medium according to claim 20, wherein determining, based on the first duration and the second duration, the start and end moments at which the UE switches between the UL service and the SL service comprises:
in response to the first duration being greater than the second duration, determining, based on the priority of the UL service and the priority of the SL service, the start and end moments at which the UE switches between the UL service and the SL service.
